(19) United States
(12) Patent Application Publication
(10) Pub. No.: US 2017/0318469 A1
(43) Pub. Date: Nov. 2, 2017

(54) METHOD, APPARATUSES AND SYSTEM FOR MANAGING DYNAMIC NETWORK RESOURCE POOLS

(71) Applicant: Nokia Solutions and Networks Oy, Espoo (FI)

(72) Inventors: Eva Perez, München (DE); Christian Markwart, München (DE); Ruediger Halfmann, Otterberg (DE)

(73) Assignee: Nokia Solutions and Networks Oy, Espoo (FI)

(21) Appl. No.: 15/531,829

(22) PCT Filed: Dec. 1, 2014
(86) PCT No.: PCT/EP2014/076079

§ 371 Date: May 31, 2017

(51) Int. Cl. H04W 16/10

(52) U.S. Cl. CPC H04W 16/10

(57) ABSTRACT

A method and apparatus may configure a first network-resource pool and a second network-resource pool. At least one network resource may correspond to the first network-resource pool. At least one network resource may correspond to the second network-resource pool. The method may also include receiving a request to provide a requested network resource. The request may be received from a requesting network. The method may also include determining whether the requested network resource matches any network resource in the first network-resource pool or the second network-resource pool. The method may also include determining whether to perform a relocation procedure to relocate a network resource corresponding to the requested network resource from one network-resource pool to the other network-resource pool. The method may also include performing the relocation procedure, if the relocation procedure is determined to be performed. The method may also include providing the requested network resource.

### BACKGROUND

### Field

Embodiments of the invention relate to managing dynamic network resource pools in network resource sharing scenarios.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data. LTE is one example of a type of Radio Network. LTE networks and other networks (such as Internet-Protocol networks, for example) may encounter similar problems when network resources are to be shared. For Internet-Protocol networks, one example of network resources to be shared may be Internet-Protocol addresses.

### SUMMARY

According to a first embodiment, a method may include configuring a first network-resource pool and a second network-resource pool. At least one network resource may correspond to the first network-resource pool. At least one network resource may correspond to the second network-resource pool. The method may also include receiving, by a network entity, a request to provide a requested network resource, wherein the request is received from a requesting network. The method may also include determining whether the requested network resource matches any network resource in the first network-resource pool or the second network-resource pool. The method may also include determining whether to perform a relocation procedure to relocate a network resource corresponding to the requested network resource from one network-resource pool to the other network-resource pool. The method may also include performing the relocation procedure, if the relocation procedure is determined to be performed. The method may also include providing the requested network resource.

In the method of the first embodiment, the network resources may include spectrum resources, the at least one network resource that corresponds to the first network-resource pool may be initially assigned to the first network-resource pool.

In the method of the first embodiment, a first set of characteristics may be associated with the first network-resource pool. A second set of characteristics may be associated with the second network-resource pool. The first set of characteristics may be applicable to the network resources of the first network-resource pool. The second set of characteristics may be applicable to the network resources of the second network-resource pool. The characteristics may comprise at least one of user restrictions/authorizations, a priority in a scheme of priorities, technical parameters, and a set of policy rules.

In the method of the first embodiment, the network entity may comprise a network-resource management function.

In the method of the first embodiment, the method may further include determining whether the requested resource is assigned to another network different than the requesting network. The requested resource may be blocked off if the requested resource is already assigned to another network.

In the method of the first embodiment, the method may further include balancing the amounts of network resources between the first network-resource pool and the second network-resource pool. The balancing may be performed in accordance to a predefined policy, and the balancing may change the applicable characteristics of at least one network resource by moving the at least one network resource from one network-resource pool to another network-resource pool.

According to a second embodiment, an apparatus may include configuring means for configuring a first network-resource pool and a second network-resource pool. At least one network resource may correspond to the first network-resource pool, and at least one network resource may correspond to the second network-resource pool. The apparatus may also include receiving means for receiving a request to provide a requested network resource. The request may be received from a requesting network. The apparatus may also include first determining means for determining whether the requested network resource matches any network resource in the first network-resource pool or the second network-resource pool. The apparatus may also include second determining means for determining whether to perform a relocation procedure to relocate a network resource corresponding to the requested network resource from one network-resource pool to the other network-resource pool. The apparatus may also include performing means for performing the relocation procedure, if the relocation procedure is determined to be performed. The apparatus may also include providing means for providing the requested network resource.

In the apparatus of the second embodiment, the network resources may comprise spectrum resources. The at least one network resource that corresponds to the first network-resource pool may be initially assigned to the first network-resource pool.

In the apparatus of the second embodiment, a first set of characteristics may be associated with the first network-resource pool, a second set of characteristics may be associated with the second network-resource pool, the first set of characteristics may be applicable to the network resources of the first network-resource pool, the second set of characteristics may be applicable to the network resources of the second network-resource pool, and the characteristics may comprise at least one of user restrictions/authorizations, a priority in a scheme of priorities, technical parameters, and a set of policy rules.

In the apparatus of the second embodiment, the apparatus may include a network-resource management function.

In the apparatus of the second embodiment, the apparatus may further include third determining means to determine whether the requested resource is assigned to another network different than the requesting network. The requested resource may be blocked off if the requested resource is already assigned to another network.

In the apparatus of the second embodiment, the apparatus may further comprise balancing means to balance the amounts of network resources between the first network-resource pool and the second network-resource pool. The balancing may be performed in accordance to a predefined policy, and the balancing changes the applicable characteristics of at least one network resource by moving the at least one network resource from one network-resource pool to another network-resource pool.

According to a third embodiment, a computer program product may be embodied on a non-transitory computer readable medium. The computer program product may be configured to control a processor to perform the method of the first embodiment.

According to a fourth embodiment, a method may include requesting, by a network entity, a network resource. The requesting the network resource may comprise requesting the network resource from a first network-resource pool and a second network-resource pool. At least one network resource may correspond to the first network-resource pool, and at least one network resource may correspond to the second network-resource pool. The method may also include receiving a generated command based on the requested network resource. The method may also include initiating the generated command. The method may also include reporting the result of initiating the generated command.

In the method of the fourth embodiment, the network entity may comprise a Resource Controller Function.

In the method of the fourth embodiment, the receiving the generated command may comprise receiving at least one of a grant/assign command and an evacuation command.

According to a fifth embodiment, an apparatus may comprise requesting means to request a network resource. The requesting the network resource may comprise requesting the network resource from a first network-resource pool and a second network-resource pool, at least one network resource may correspond to the first network-resource pool, and at least one network resource may correspond to the second network-resource pool. The apparatus may also include receiving means to receive a generated command based on the requested network resource. The apparatus may also include initiating means to initiate the generated command. The apparatus may also include reporting means to report the result of initiating the generated command.

In the apparatus of the fifth embodiment, the apparatus may comprise a Resource Controller Function.

In the apparatus of the fifth embodiment, the receiving the generated command may comprise receiving at least one of a grant/assign command and an evacuation command.

According to a sixth embodiment, a computer program product may be embodied on a non-transitory computer readable medium. The computer program product may be configured to control a processor to perform the method of the fourth embodiment.

According to a seventh embodiment, a system may comprise a first apparatus. The first apparatus may comprise configuring means for configuring a first network-resource pool and a second network-resource pool. At least one network resource may correspond to the first network-resource pool, and at least one network resource may correspond to the second network-resource pool. The first apparatus may also include first receiving means for receiving a request to provide a requested network resource. The request may be received from a requesting network. The first apparatus may also include first determining means for determining whether the requested network resource matches any network resource in the first network-resource pool or the second network-resource pool. The first apparatus may also include second determining means for determining whether to perform a relocation procedure to relocate a network resource corresponding to the requested network resource from one network-resource pool to the other network-resource pool. The first apparatus may also include performing means for performing the relocation procedure, if the relocation procedure is determined to be performed. The first apparatus may also include providing means for providing the requested network resource. The system may also include a second apparatus. The second apparatus may comprise requesting means to request the network resource. The requesting the network resource may comprise requesting the network resource from the first network-resource pool and the second network-resource pool. The second apparatus may also include second receiving means to receive a generated command based on the requested network resource. The second apparatus may also include initiating means to initiate the generated command. The second apparatus may also include reporting means to report the result of initiating the generated command.

According to an eighth embodiment, an apparatus may include at least one processor. The apparatus may also include at least one memory including computer program code. The at least one memory and the computer program code may be configured, with the at least one processor, to cause the apparatus at least to configure a first network-resource pool and a second network-resource pool. At least one network resource may correspond to the first network-resource pool. At least one network resource may correspond to the second network-resource pool. The apparatus may also be caused to receive a request to provide a requested network resource. The request may be received from a requesting network. The apparatus may also be caused to determine whether the requested network resource matches any network resource in the first network-resource pool or the second network-resource pool. The apparatus may also be caused to determine whether to perform a relocation procedure to relocate a network resource corresponding to the requested network resource from one network-resource pool to the other network-resource pool. The apparatus may also be caused to perform the relocation procedure, if the relocation procedure is determined to be performed. The apparatus may also be caused to provide the requested network resource.

According to a ninth embodiment, an apparatus may include at least one processor. The apparatus may also include at least one memory including computer program code. The at least one memory and the computer program code may be configured, with the at least one processor, to cause the apparatus at least to request a network resource. The requesting the network resource may comprise requesting the network resource from a first network-resource pool and a second network-resource pool. At least one network resource may correspond to the first network-resource pool, and at least one network resource may correspond to the second network-resource pool. The apparatus may also be caused to receive a generated command based on the requested network resource. The apparatus may also be caused to initiate the generated command. The apparatus may also be caused to report the result of initiating the generated command.

### BRIEF DESCRIPTION OF THE DRAWINGS

For proper understanding of the invention, reference should be made to the accompanying drawings, wherein:

FIG. 1 illustrates an example functional configuration in accordance with certain embodiments of the present invention.

FIG. 2 illustrates an example of a method for dynamic network resource handling in accordance with certain embodiments of the present invention.

FIG. 3 illustrates an example of the subroutine “determining whether a network resource in a pool matches a request” in accordance with certain embodiments of the present invention.

FIG. 4 illustrates an example of the subroutine “start NR relocation procedure” for shifting a network resource from one pool to another pool in accordance with certain embodiments of the present invention.

FIG. 5 illustrates an example for receiving an asynchronous “evacuation is finalized event” from the RCF that triggers a network-resource relocation procedure in accordance with certain embodiments of the present invention.

FIG. 6 illustrates a sharing scenario based on a 3 tiered model in accordance with certain embodiments of the present invention.

FIG. 7 illustrates requesting a network resource in accordance with certain embodiments of the present invention.

FIG. 8 illustrates a flowchart of a method in accordance with certain embodiments of the invention.

FIG. 9 illustrates a flowchart of a method in accordance with certain embodiments of the invention.

FIG. 10 illustrates an apparatus in accordance with certain embodiments of the invention.

FIG. 11 illustrates an apparatus in accordance with certain embodiments of the invention.

FIG. 12 illustrates an apparatus in accordance with certain embodiments of the invention.

FIG. 13 illustrates a system in accordance with embodiments of the invention.

### DETAILED DESCRIPTION

Embodiments of the invention relate to managing dynamic network resource pools in network resource sharing scenarios. Embodiments of the present invention may relate to Radio-Access Networks (RAN) that include base stations (such as Macro base stations, Pico base stations, and Femto base stations, for example). The base stations may use resources (such as spectrum, for example) to extend the capacity/capabilities of broadband wireless access. Spectrum is merely one example of network resources that may be shared. In addition to licensed and license-exempt (unlicensed) methods of authorizing use of spectrum, new spectrum-sharing concepts (such as Licensed Shared Access (LSA) or co-primary spectrum sharing) are discussed to improve the capacity/capability of mobile networks. For example, these spectrum-sharing concepts are discussed in “EU RSPG: Report on Collective Use of Spectrum (CUS) and other spectrum sharing approaches RSPG11-392.” New spectrum management approaches may be required to meet the requirements for accessing/using flexible spectrum.

LSA is an example of using a flexible spectrum. The flexible spectrum may be owned by an Incumbent (primary user). The Incumbent may allow other licensed operators to use this flexible spectrum for their own purposes. LSA may support different operators by using separated LSA spectrum resources. Each LSA spectrum resource may be defined by the spectrum to which this resource corresponds to, a location where this spectrum is used, and a time frame when the spectrum is used at the defined location.

Spectrum utilization and allocation has generally been performed in accordance with static configurations. These static configurations may be based on the network planning data of a Mobile Network Operator (MNO). With the introduction of LSA, the continued use of these static configurations may no longer be possible. Using the static configurations may no longer be possible because the LSA spectrum may need to be evacuated according to predefined terms and conditions, if such evacuation is requested by the Incumbent (primary user).

In general, the principle of “my spectrum—my usage” will likely not hold any longer. In other words, the previous static spectrum allocation methods may need to be complemented. Complementing the existing static spectrum allocations methods may lead to a paradigm change in the mobile communication industry. In contrast to the traditional manner of assigning exclusive spectrum, certain parts of the spectrum may no longer be exclusively assigned to a single operator. Rather, certain parts of the spectrum may be jointly assigned to several operators. The several operators may have the obligation to collectively use the spectrum.

Spectrum sharing via LSA may support static-sharing modes and dynamic-sharing modes. With static-sharing modes, there may be no time dependencies, and the LSA Licensee may be allowed to use the spectrum in a similar manner as using a dedicated licensed spectrum. On the other hand, with dynamic sharing, the sharing may provide flexible controlling of shared spectrum resources by the owner of the spectrum resource (for example, an Incumbent).

Spectrum resources may be organized in spectrum pools. The spectrum pools may contain spectrum resources that are no longer bound to a specific Licensee, and the spectrum resources may be used by a predefined number of licensees. Spectrum pools may allow dynamic sharing of spectrum between spectrum owners and spectrum users. Spectrum pools may also enable implementation of flexible-spectrum licensing models.

There have not been any current plans to implement dynamic management of spectrum pools to enable spectrum resources to be transferred between the different pools (when the transferring is performed in response to market demands for spectrum). One dynamic-sharing scenario is described in the white paper “Toward more efficient spectrum management.” This sharing scenario may be based on a three-tiered model identified by the United States President's Council of Advisors on Science and Technology (PCAST) report, where the three tiers are: (1) Access by Incumbent Users, (2) Priority Access (PA), and (3) Generalized Authorized Access (GAA).

Spectrum resources may be organized in a plurality of pools. In one example, the spectrum resources may be organized in two different pools: Pool A and Pool B. Pool A may contain spectrum resources for the PA users, and pool B may contain spectrum resources for the GAA users. PA users may need to complete/perform a licensing process in order to access to the spectrum resources of pool A, while GAA users may access the spectrum resources of pool B (on demand) after a simplified registration procedure. The Incumbent users may access the spectrum resources of both pools. The Incumbent users may access the spectrum resources in a manner similar to the manner of spectrum sharing under LSA. As such, the Incumbent users may use the spectrum whenever using the spectrum is required by them. The availability of the spectrum resources for PA and GAA users may be controlled by the Incumbent users. The availability of the spectrum resources for the PA and GAA users may be determined based upon: (1) ownership of the spectrum resource by the Incumbent user, and (2) the sharing rules that are agreed upon between the Regulator and the sharing partners. The discussions about the pool sizes and about the implementation of corresponding spectrum-resource management have not been finalized. For example, the discussions have not finalized how many spectrum resources are provided to pool A, nor finalized how many spectrum resources are provided to pool B.

Certain embodiments of the present invention may be directed to a method that may (1) dynamically assign or un-assign spectrum resources to a pool, and/or (2) dynamically transfer spectrum resources from one pool to another pool. Certain embodiments of the present invention may involve a network resource management function (NRMF), which may determine a number of resource pools and determine a number of network resources for the resource pools. In certain embodiments, the NRMF may determine the number of network resource for each pool. The network resources may be, for example, spectrum resources in a Mobile-and-Fixed-Communications Network (MFCN). Each network resource may be pre-assigned to one resource pool. The NRMF may allow the dynamic extension and reduction of both the resource pools and the network resources, and the NRMF may introduce a method that allows the relocation of one or a set of network resources from a first pool (where the network resource(s) is/are currently assigned) to a second pool, either on demand or as automated via a policy control mechanism. In certain embodiments, the second resource pool may be empty during initialization or during an operational phase.

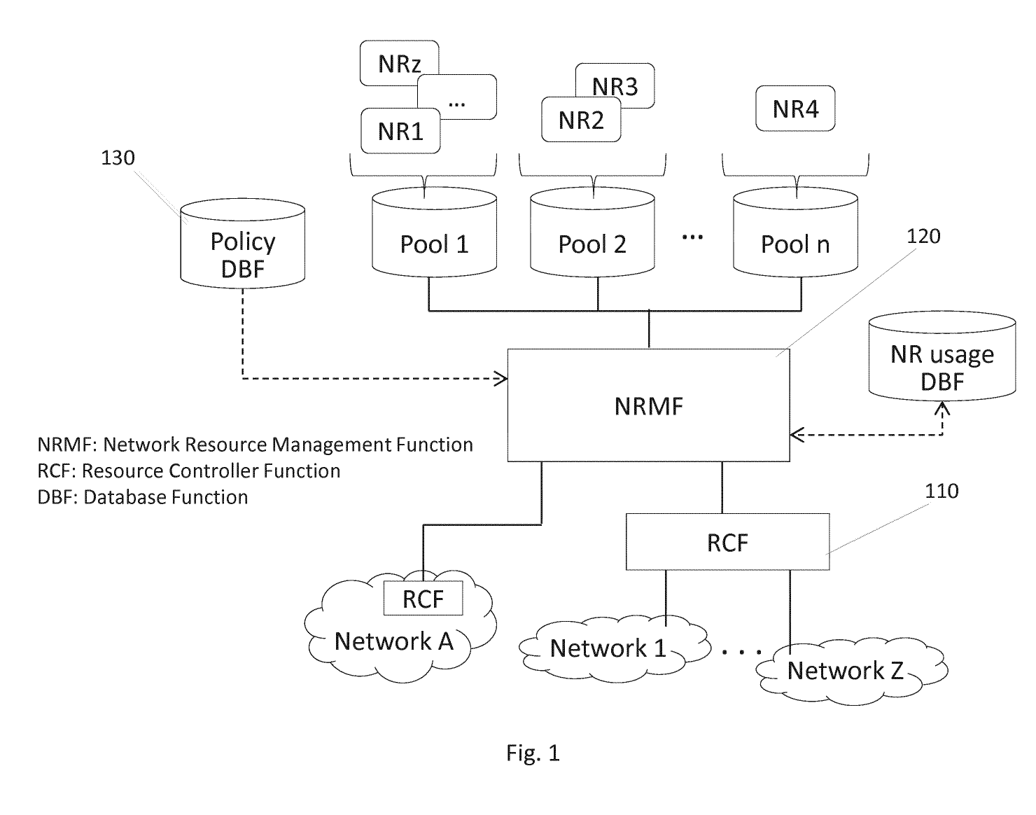

FIG. 1 illustrates an example functional configuration in accordance with certain embodiments of the present invention. Each Network Resource (NR x) may be pre-assigned to a Resource Pool y. Each pool may include a defined set of characteristics. The characteristics of a given pool may be applicable, by extension, to the network resources that are assigned to this given pool. These characteristics may describe, for example, user restrictions/authorizations, a priority in a scheme of priorities, a set of policy rules for usage of the respective network resources, and further group attributes for network resources assigned to this pool. In certain embodiments, a set of characteristics may be one of two types. With a first type of characteristics, the characteristics may include technical characteristics of an NR belong to a pool such as, for example, bandwidth, power levels, and/or restrictions for the NR. With a second type of characteristics, the characteristics may include authorization characteristics of an NR that belongs to a pool such as, for example, access to NR of a pool, licensing method, and/or policy rules for assignment.

As described in more detail below, if a network resource is moved/relocated from a first resource pool to a second resource pool, the moved/relocated network resource will then adopt the characteristics of the second resource pool. As such, the characteristics associated with the network resource may be changed by moving the network resource to a different resource pool. Changing the characteristics of the network resources enables embodiments of the present invention to make network resources available to a requesting network, for example, that: (1) only has access to a network resource in a specific pool, and/or (2) requires other technical characteristics of a network resource before the network resource may be used in the requesting network, as described in more detail below.

A network may request a network resource or a set of network resources that may be necessary for operating the network. The network resource or the set of network resources may be requested via a dedicated Resource Controller Function 110 (RCF) at the NRMF 120. The RCF 110 may be its own entity or a part of an entity that belongs to the network. Further, the RCF 110 may serve several networks or a single dedicated network. The NRMF 120 may have access to the different network resources that are assigned to the different pools, and the NRMF 120 may also be connected to a Policy Data Base Function 130 (PDBF). The PDBF 130 may include policy rules (such as, for example, fairness rules or regulatory rules) for the pools and the managed network resources. The NRMF 120 may use a received request that requests a network resource (received from a requesting entity) as a trigger to determine whether or not a network resource is to be provided in the answer to the requesting entity. In one example, the received request may be received from the RCF 110.

In the event of a positive decision (where the NRMF decides to provide a network resource in the answer), the NRMF may decide which network resource is provided in the answer to the requesting entity. The decision may be based on information from PDBF such as, for example, information relating to current network resource usage and/or statistical network resource usage. The decision may also be based on additional information, like network consumer details, provided in the request. Information, such as information relating to current network resource usage and/or statistical network resource usage, is either monitored at the NRMF or provided via reports from the Network or RCF. The NRMF may update this information on a regular basis and may store this updated information in the Network Resource (NR) usage database function.

The NRMF may further include a procedure that enables dynamic extension and reduction of both the resource pools and the network resources. The reduction may be performed in a controlled manner. The NRMF may also introduce a method that allows shifting of one or a set of network resources from one pool (where the network resource(s) is/are currently assigned) to another pool, either on demand or as automated via a policy control mechanism.

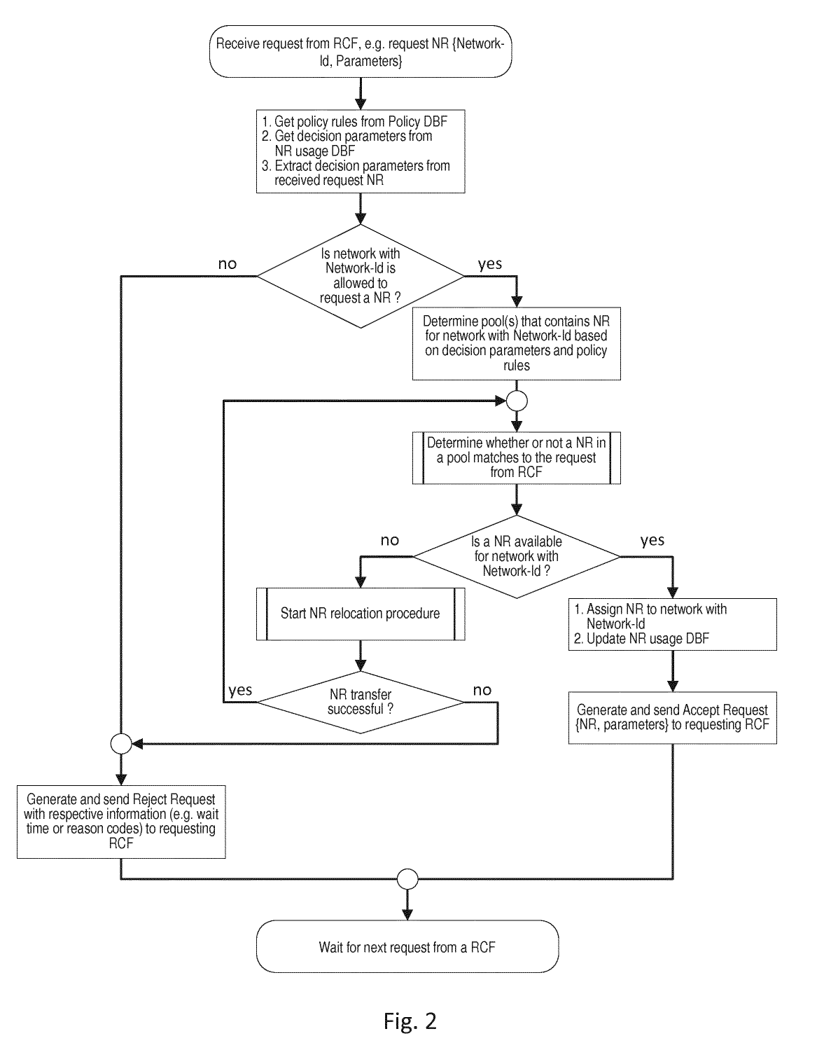

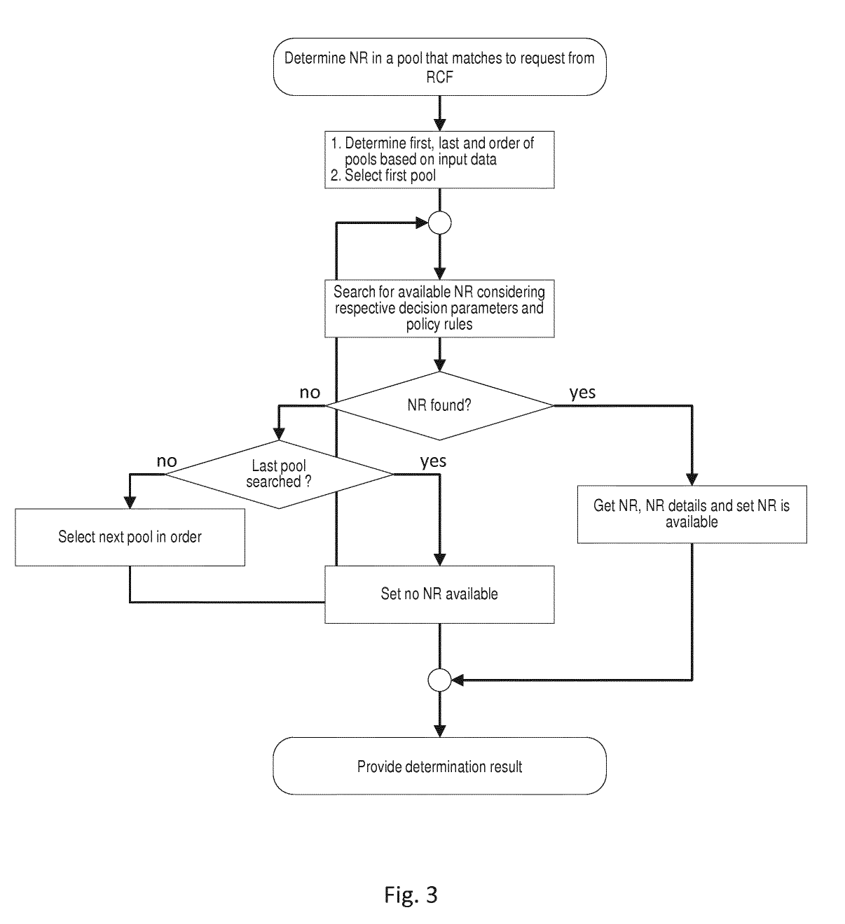

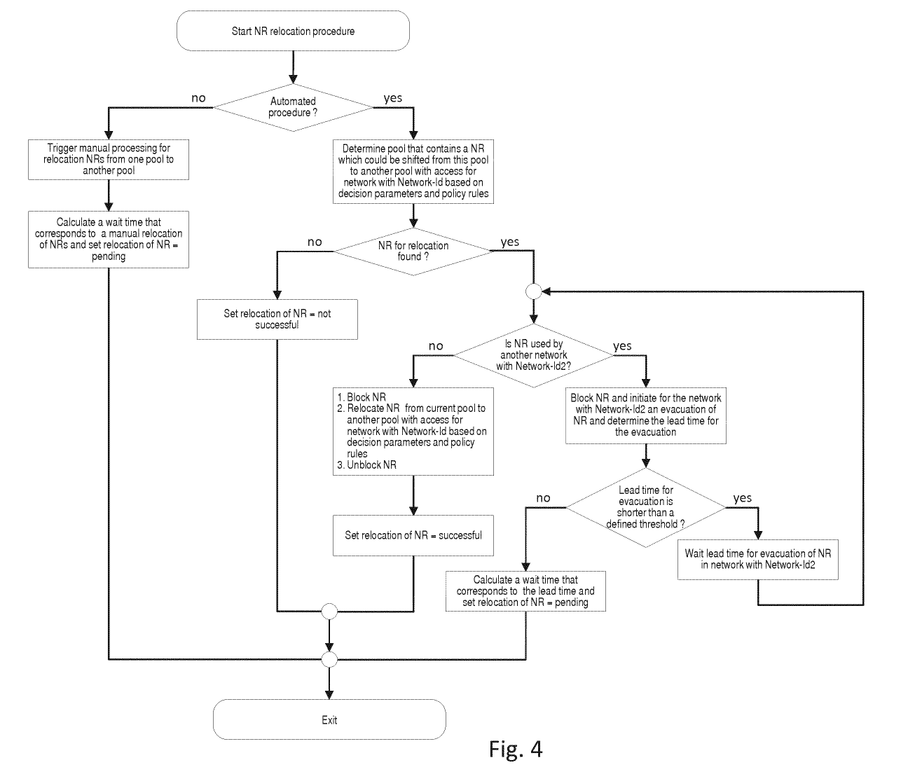

FIG. 2 illustrates a method for dynamic network resource handling in accordance with certain embodiments of the present invention. Specifically, FIG. 2 illustrates an example of how the NRMF implements dynamic network resource handling for a scenario where the network of an operator is allowed to use network resources from different pools. After receiving an NR request from an RCF, the NRMF may first obtain the policy (from the PDBF) and decision parameters from network resource usage. According to the obtained information, the NRMF may check if the requesting network (identified with Network-Id) is allowed to request an NR. If the requesting network is not allowed to request the NR, a “Reject Request” message is generated and sent to the requesting RCF. If the requesting network is allowed to request the NR, the NRMF will first determine which is the pool with the requested network characteristics, and if the pool contains an available NR. As illustrated by FIG. 2, if (1) a requested network resource matches a network resource of a resource pool, and (2) the requesting network does not have access to the resource pool that has the matching network resource, the requested resource may be relocated from its current resource pool to a different resource pool that is accessible by the requesting network. FIG. 3 illustrates an example subroutine that determines whether or not an NR in a pool matches a request from RCF. The example subroutine of FIG. 3 corresponds to the step “Determine whether or not a NR in a pool matches to the request from RCF” of FIG. 2. FIG. 4 illustrates an example of the subroutine “start NR relocation procedure” for shifting a network resource from one pool to another pool in accordance with certain embodiments of the present invention. The example subroutine of FIG. 4 corresponds to the step “Start NR relocation procedure” of FIG. 2. FIG. 3 and FIG. 4 illustrates an example relocation procedure for shifting an NR from one pool to another pool.

In one illustrative scenario, a network resource may be used by only one network at a time (i.e., if a network resource is already assigned to a network, this network resource cannot be assigned to another network). Embodiments of the present invention are not necessarily limited to this scenario, and other embodiments of the present invention may be used in other scenarios which allow the sharing of a network resource by different operator networks. Differentiation between the scenario types may be enabled by using the policy rules stored in the PDBF. The organization of the network resources in different pools may be configured such that different policy rule sets may be used for each different pool.

Before the requesting/responding exchange between the NRMF and the RCF, a connection setup including authentication and authorization may be performed. After the connection setup, the NRMF may receive NR requests from the RCF, and the NRMF may initiate relocations of NR from one pool to another pool. Each request may contain information on the network requesting the NR and may contain further parameters. The further parameters may depend on the supported scenario, and the parameters may be used to provide further information about the requesting network. For example, if a network can only use a specific NR, the identification of this NR may be provided as a parameter.

FIG. 3 illustrates determining whether a network resource matches a request in accordance with certain embodiments of the present invention. Specifically, FIG. 3 illustrates an example procedure for determining whether or not an NR (in a pool) matches a request from RCF. In one illustrative example, a requesting network may have access to network resources in more than one pool. Such a scenario may occur when, for example, a mobile network operator is allowed to use spectrum resources that are licensed and/or unlicensed. The RCF may then request a dedicated licensed spectrum that specifically supports Quality-of-Service (QoS) to the subscribers.

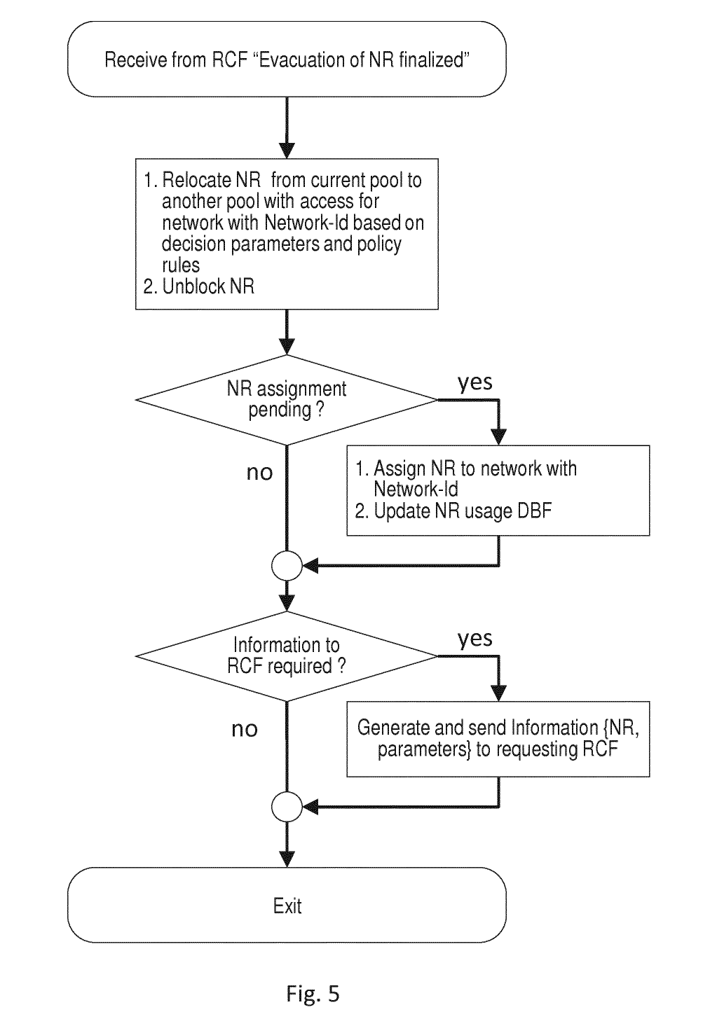

FIG. 4 and FIG. 5 illustrate an example NR-relocation procedure. The relocation of a NR may be required when there are no NRs available at a given pool (the given pool having characteristics that correspond to the characteristics of the requesting network), but where NRs are available at another pool. Additionally, if there is an NR at the other pool, the NR being assigned to another network, but the policy determines that the NR must be assigned to the requesting network, this NR will be evacuated before being transferred to the other pool. The NR-relocation procedure may be started whenever network resources are to be shifted from one pool to another pool. The NRMF perform controlling of the managed network resources in such a way that a network resource can be granted/assigned to a network and/or evacuated from the assigned network, whenever necessary. The grant/assign and evacuation commands may be generated by NRMF, and the commands may be sent from NRMF to RCF. The RCF may initiate the respective measures for the NR in the network, and the RCF may report the result when the execution of the command has finished. The time between the sending of the command and the receiving of the report may be defined as a lead time. The time may reflect how long it takes to finalize/execute the action of the command. In the event that the relocation of an NR is defined as an automated procedure, distinguishing between fast evacuations and evacuations that require a longer time period may be helpful. When a longer time period is necessary, the NR relocation procedure may provide this result/indication (which indicates that the longer time period is necessary) to the NRMF. The NRMF may then inform the RCF about the pending relocation, and the NRMF may provide information relating to when an NR is expected to be available.

Referring to FIG. 2, a pending relocation may occur during the “Start NR relocation procedure” step. FIG. 4 illustrates steps that may be performed when a pending relocation may be required. The RCF may use the information provided by the NRMF to issue a new request after the reported time. The reported lead time indicates the time that is needed to evacuate the NR (when needed) before attempting the NR assignment to the requesting network. Alternatively (not shown in FIG. 2), the pending result may be signaled as an Accept response. In the latter case, the “not successful” and “pending” state may need to undergo additional checking. If there is no NR available for the requesting network at the corresponding pool, and there is no available matching NR at other pools, the state is “not successful.” If there is a matching and available NR at another pool, but the NR must be evacuated, the state will be “pending.” When the pending case is detected, an Accept Request may be generated instead of a Reject.

Certain embodiments of the present invention may select a specific NR in a pool for relocation. Certain embodiments of the present invention may use information from an NR-usage DBF (in combination with policy rules from the PDBF) to determine an appropriate NR for relocation. When an NR is identified to be relocated, certain embodiments of the present invention may check whether or not the identified NR has already been assigned to a network. In the event that the NR has already been assigned, the NR may be blocked off in order to avoid the possibility that, during the relocation, another request for this NR is performed such that the resource is evacuated from the assigned network.

In the event that the Relocation procedure is to be performed independent from or asynchronous to the NR request-response mechanism, the Relocation procedure and the respective relocation result check (as illustrated by FIG. 2) may be skipped. The relocation procedure may then be started via a graphical user interface (GUI) or via a scheduler function at the NRMF.

FIG. 5 illustrates an example for receiving an asynchronous “evacuation is finalized event” from the RCF that triggers a network-resource relocation procedure in accordance with certain embodiments of the present invention. When relocating a network resource (NR) from one pool to another pool, this NR may need to not be currently used in any network. To avoid collisions relating to the NR when performing a relocation procedure with an NR request-assignment procedure, the NR may be blocked for new assignments. Because the evacuation of the network resource may require a pre-defined lead time, in such situations, it may be necessary to wait for the finalization of the evacuation procedure. Typically, this finalization may be signaled by the RCF as “evacuation of NR is finalized,” as described in FIG. 5. Specifically, FIG. 5 illustrates a second part of the relocation procedure. The second part of the relocation procedure may be performed when the evacuation lead time for the NR requires a longer period of time to complete, and the result of the initiated relocation, as shown in FIG. 4, is received too late. Depending on the network scenario, the relocated NR (asynchronous to the network) may be assigned with the Network-Id. The Network-Id refers to a particular network (identified with Network-Id). Certain embodiments of the present invention may inform this network that the new NR is now available for usage.

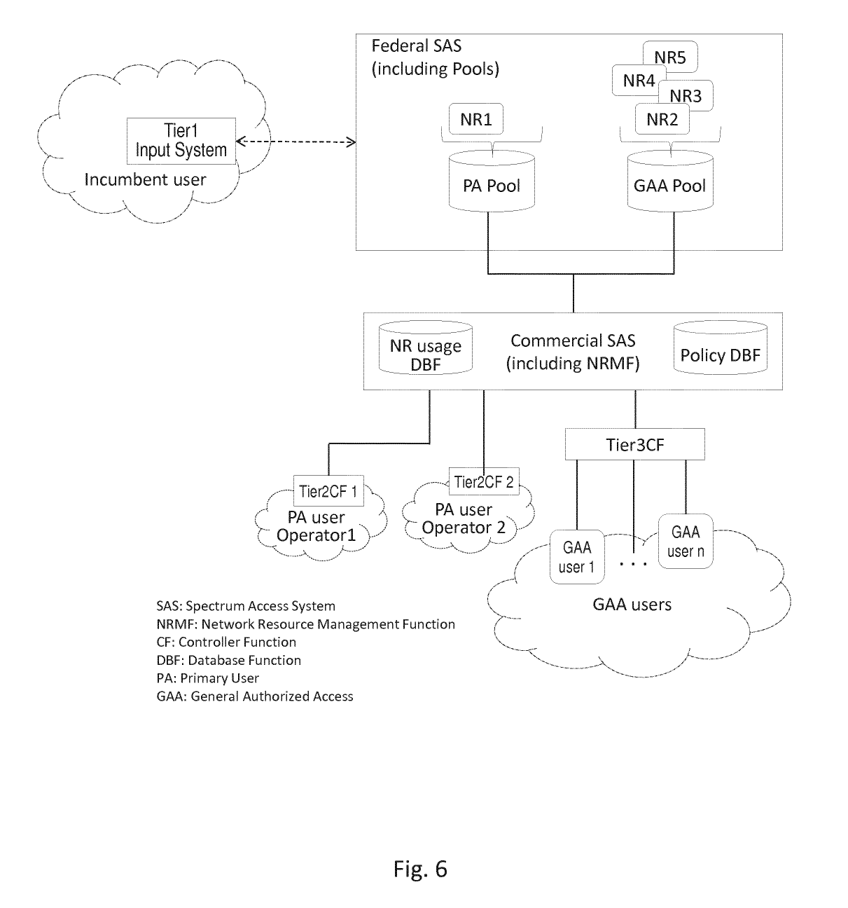

FIG. 6 illustrates a sharing scenario based on a 3 tiered model in accordance with certain embodiments of the present invention. FIG. 6 illustrates a sharing scenario of a 25 MHz spectrum based on the three-tiered model proposed by the Federal Communications Commission (FCC). The 25 MHz spectrum resource may be subdivided into 5 NRs (i.e., each NR may be on a spectrum fragment of 5 MHz). The tier 1 users may be privileged to access Spectrum, whenever the tier 1 users require Spectrum. To provide this privileged access, certain LSA concepts may be used, and the Tier 1 user may be mapped to the incumbent role. Additionally, the tier 2 and the tier 3 users may be mapped to the LSA Licensee roles. While tier 2 users (PA users) may require a license to access the PA pool, tier 3 users (GAA users) may access an NR in the GAA pool by following a simplified registration procedure. Access to the NRs may be controlled by two Spectrum Access Systems (SAS). The two SAS may act as distributed LSA Repositories: a federal SAS and a commercial SAS. The federal SAS may include two spectrum pools, one for PA users and one for GAA users. The two spectrum pools may are also accessible by the Tier 1 users. The commercial SAS may contain the NR usage database, the policy database, and the NRMF. As described above, the NRMF may control the size of the pools and may control the access to the pools.

The policy rules may request that unused NRs be initially provided to the GAA pool. The policy rules may balance an equal share of NRs among the PA and GAA pools. For example, 50% of NRs may initially be for the PA pool, and 50% of the NRs may initially be for the GAA pool. The PA (Tier 2) and GAA (Tier 3) users may request NRs through the commercial SAS, where the NRMF may process the request. The NRMF may assign an NR or reject the request. The NRMF may reallocate an NR among the different pools if needed, according to the policy.

In another embodiment, 20% of the network resources (NR1) may initially be configured at the PA pool to be used by Operator 1 (PA user), and the remaining 80% of the resources (NR2-NR5) may initially be configured at the GAA pool to be used by GAA users.

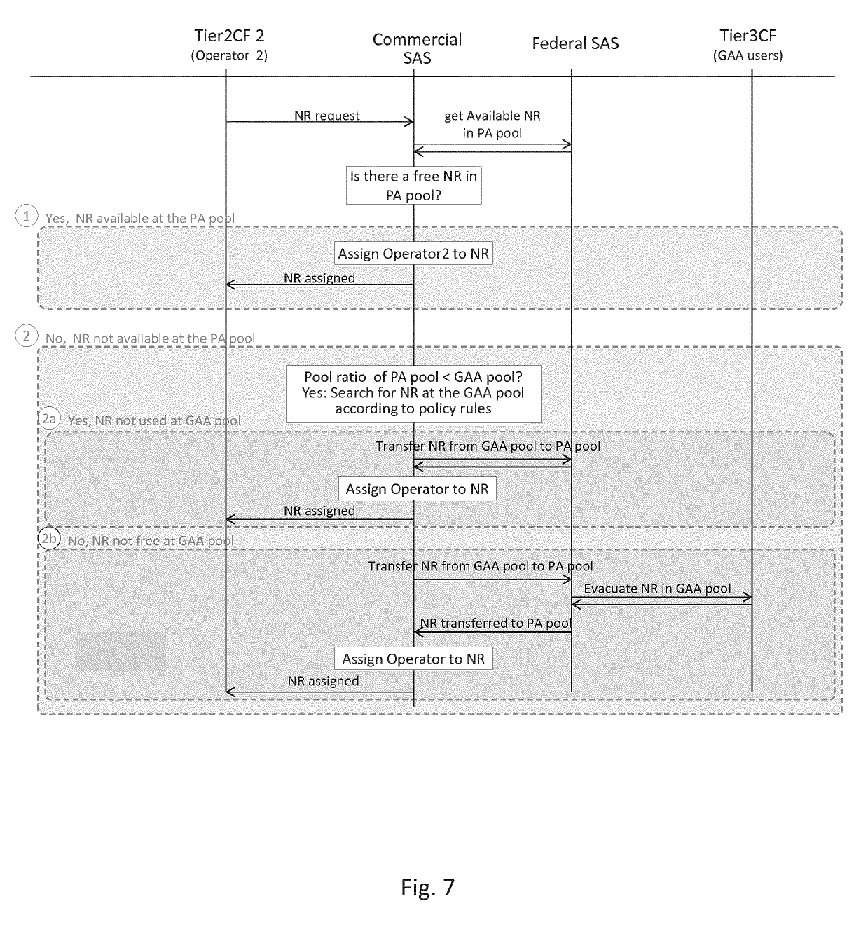

FIG. 7 illustrates requesting a network resource in accordance with certain embodiments of the present invention. When a new PA user (Operator 2) has been licensed, enters the scenario, and requests an NR to the commercial SAS (as illustrated in FIG. 7), the commercial SAS may obtain the NR availability from the federal SAS. If there is an available NR in the PA pool, the NR may be assigned to Operator 2. If there is no available NR, the NRMF may search for a NR at the GAA pool in accordance with the policy rules. If there is a free NR at the GAA pool, the NR may be blocked for GAA users and transferred to the PA pool. The NR may then be assigned to Operator 2. If there is no free NR available at the GAA pool, the relocation procedure may be started. Because the PA pool is using just 20% of the resources, which is less than 50%, one of the NR from the GAA pool may be evacuated and transferred to the PA pool. The NR may then be assigned to Operator 2.

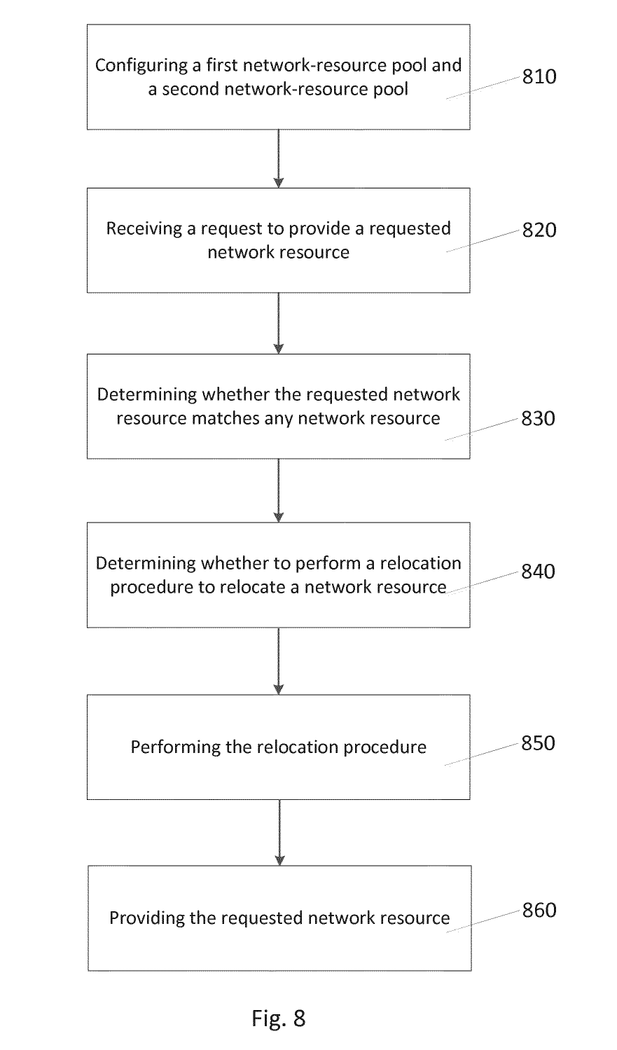

FIG. 8 illustrates a flowchart of a method in accordance with embodiments of the invention. Embodiments are presented in further detail above by means of FIGS. 1 to 7. The method illustrated in FIG. 8 includes, at 810, configuring a first network-resource pool and a second network-resource pool. At least one network resource may correspond to the first network-resource pool. At least one network resource may correspond to the second network-resource pool. The method may also include, at 820, receiving, by a network entity, a request to provide a requested network resource. The request may be received from a requesting network. The method may also include, at 830, determining whether the requested network resource matches any network resource in the first network-resource pool or the second network-resource pool. The method may also include, at 840, determining whether to perform a relocation procedure to relocate a network resource corresponding to the requested network resource from one network-resource pool to the other network-resource pool. The method may also include, at 850, performing the relocation procedure, if the relocation procedure is determined to be performed. The method may also include, at 860, providing the requested network resource.

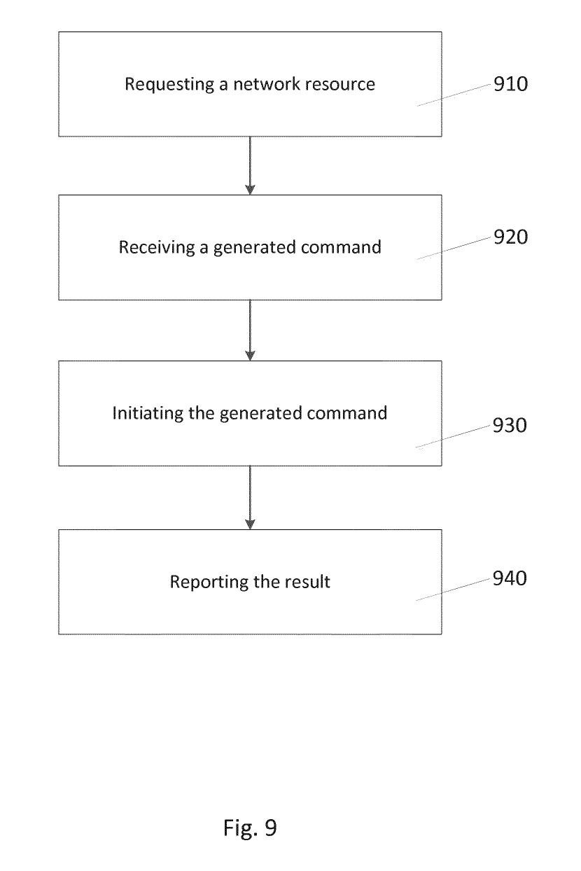

FIG. 9 illustrates a flowchart of a method in accordance with embodiments of the invention. Embodiments are presented in further detail above by means of FIGS. 1 to 7. The method illustrated in FIG. 9 includes, at 910, requesting a network resource. The requesting the network resource may include requesting the network resource from a first network-resource pool and a second network-resource pool. At least one network resource may correspond to the first network-resource pool. At least one network resource may correspond to the second network-resource pool. The method may include, at 920, receiving a generated command based on the requested network resource. The method may also include, at 930, initiating the generated command. The method may also include, at 940, reporting the result of initiating the generated command.

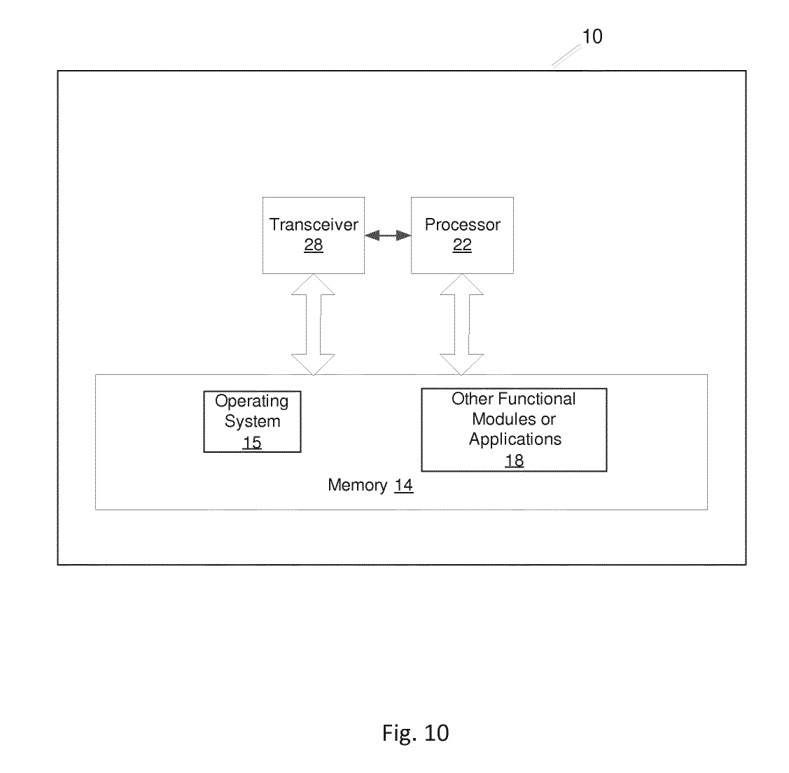

FIG. 10 illustrates an apparatus in accordance with embodiments of the invention presented above by means of FIGS. 1 to 9. In one embodiment, the apparatus may be a network element, such as an NRMF and/or RCF, for example. Apparatus 10 may include a processor 22 for processing information and executing instructions or operations. Processor 22 may be any type of general or specific purpose processor. While a single processor 22 is shown in FIG. 10, multiple processors may be utilized according to other embodiments. Processor 22 may also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks or operations as described herein. Software routines may also be downloaded into the apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Apparatus 10 may also include or be operationally coupled to one or more antennas (not shown) for transmitting and receiving signals and/or data to and from apparatus 10. Apparatus 10 may include or be operationally coupled to a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly. It should be appreciated that the apparatus may as an option to be operationally coupled to a remote radio head.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

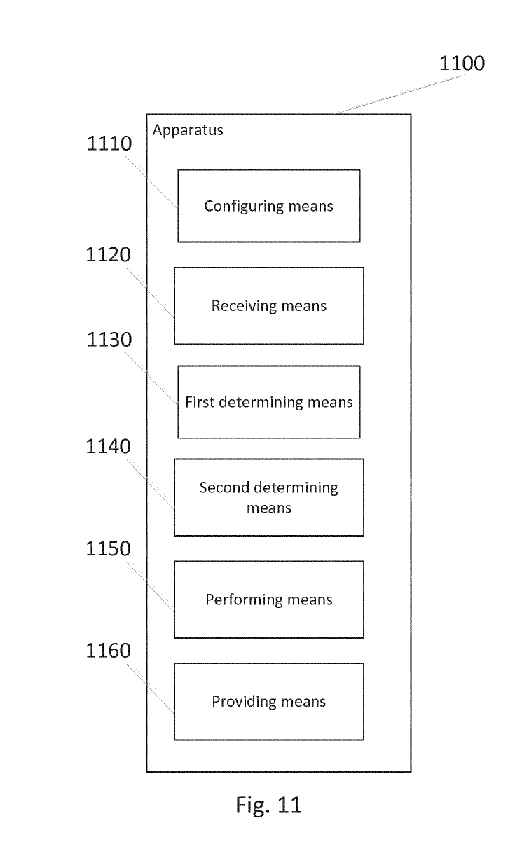

FIG. 11 illustrates an apparatus in accordance with embodiments of the invention presented above by means of FIGS. 1 to 8. Apparatus 1100 may be a network element/entity such as an NRMF, for example. Apparatus 1100 may include means 1110 for configuring a first network-resource pool and a second network-resource pool. At least one network resource may correspond to the first network-resource pool. At least one network resource may correspond to the second network-resource pool. Apparatus 1100 may also include means 1120 for receiving a request to provide a requested network resource. The request may be received from a requesting network. Apparatus 1100 may also include means 1130 for determining whether the requested network resource matches any network resource in the first network-resource pool or the second network-resource pool. Apparatus 1100 may also include means 1140 for determining whether to perform a relocation procedure to relocate a network resource corresponding to the requested network resource from one network-resource pool to the other network-resource pool. Apparatus 1100 may also include means 1150 for performing the relocation procedure, if the relocation procedure is determined to be performed. Apparatus 1100 may also include means 1160 for providing the requested network resource.

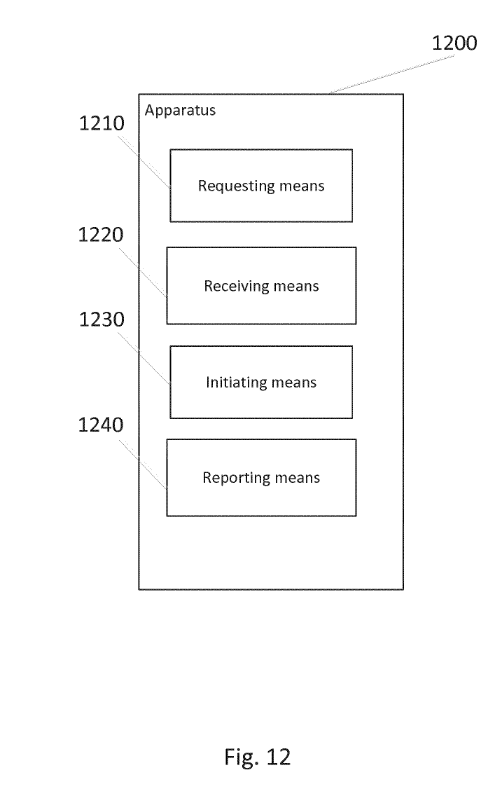

FIG. 12 illustrates an apparatus in accordance with embodiments of the invention presented above by means of FIGS. 1 to 7 and/or 9. Apparatus 1200 may be a network element/entity such as an RCF, for example. Apparatus 1200 may include means 1210 for requesting a network resource. The requesting the network resource may include requesting the network resource from a first network-resource pool and a second network-resource pool. At least one network resource may correspond to the first network-resource pool. At least one network resource may correspond to the second network-resource pool. Apparatus 1200 may also include means 1220 for receiving a generated command based on the requested network resource. Apparatus 1200 may also include means 1230 for initiating the generated command. Apparatus 1200 may also include means 1240 for reporting the result of initiating the generated command.

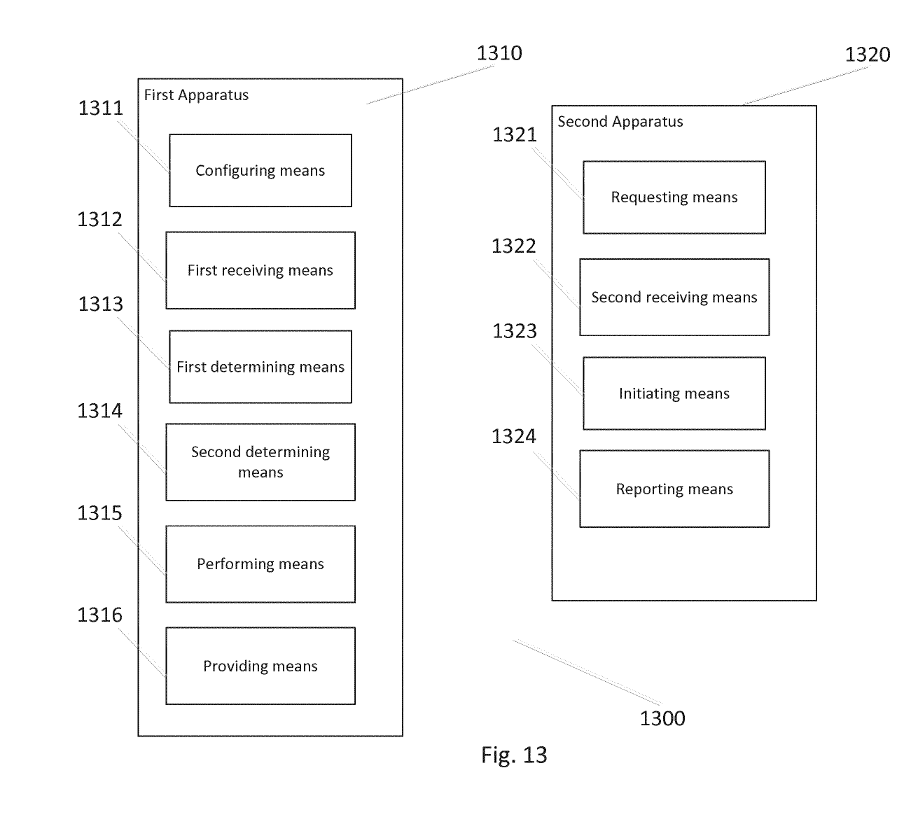

FIG. 13 illustrates a system in accordance with embodiments of the invention explained in further detail above. System 1300 may include a first apparatus 1310 comprising means 1311 for configuring a first network-resource pool and a second network-resource pool. At least one network resource may correspond to the first network-resource pool. At least one network resource may correspond to the second network-resource pool. First apparatus 1310 may include means 1312 for receiving a request to provide a requested network resource. The request may be received from a requesting network. First apparatus 1310 may also include means 1313 for determining whether the requested network resource matches any network resource in the first network-resource pool or the second network-resource pool. First apparatus 1310 may also include second determining means 1314 for determining whether to perform a relocation procedure to relocate a network resource corresponding to the requested network resource from one network-resource pool to the other network-resource pool. First apparatus 1310 may also include means 1315 for performing the relocation procedure, if the relocation procedure is determined to be performed. First apparatus 1310 may also include means 1316 for providing the requested network resource. System 1300 may also include a second apparatus 1320 including means 1321 to request the network resource. The requesting the network resource may comprise requesting the network resource from the first network-resource pool and the second network-resource pool. Second apparatus 1320 may also include means 1322 for receiving a generated command based on the requested network resource. Second apparatus 1320 may also include means 1323 for initiating the generated command. Second apparatus 1320 may also include means 1324 for reporting the result of initiating the generated command.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1-23. (canceled)

24. A method, comprising:
configuring a first network-resource pool and a second network-resource pool, wherein at least one network resource corresponds to the first network-resource pool, and at least one network resource corresponds to the second network-resource pool;
receiving, by a network entity, a request to provide a requested network resource, wherein the request is received from a requesting network;
determining whether the requested network resource matches any network resource in the first network-resource pool or the second network-resource pool;
determining whether to perform a relocation procedure to relocate a network resource corresponding to the requested network resource from one network-resource pool to the other network-resource pool;
performing the relocation procedure, if the relocation procedure is determined to be performed; and
providing the requested network resource.

25. The method according to claim 24, wherein the network resources comprise spectrum resources, the at least one network resource that corresponds to the first network-resource pool is initially assigned to the first network-resource pool.

26. The method according to claim 24, wherein a first set of characteristics is associated with the first network-resource pool, a second set of characteristics is associated with the second network-resource pool, the first set of characteristics is applicable to the network resources of the first network-resource pool, the second set of characteristics is applicable to the network resources of the second network-resource pool, and the characteristics comprise at least one of user restrictions/authorizations, a priority in a scheme of priorities, technical parameters, and a set of policy rules.

27. The method according to claim 24, wherein the network entity comprises a network-resource management function.

28. The method according to claim 24, further comprising determining whether the requested resource is assigned to another network different than the requesting network, wherein the requested resource is blocked off if the requested resource is already assigned to another network.

29. The method according to claim 24, further comprising balancing the amounts of network resources between the first network-resource pool and the second network-resource pool, wherein the balancing is performed in accordance to a predefined policy, and the balancing changes the applicable characteristics of at least one network resource by moving the at least one network resource from one network-resource pool to another network-resource pool.

30. The method according to claim 24, wherein the relocation procedure is performed if the requested network resource is in a resource pool the requesting network does not have access to.

31. The method according to claim 24, wherein the requested network resource is requested under Licensed Shared Access spectrum sharing concept.

32. An apparatus, comprising:
at least one processor and at least one memory including a computer program code, the at least one memory and the computer program code configured to, with the at least one processor, cause the apparatus at least to:
configure a first network-resource pool and a second network-resource pool, wherein at least one network resource corresponds to the first network-resource pool, and at least one network resource corresponds to the second network-resource pool;
receive, by a network entity, a request to provide a requested network resource, wherein the request is received from a requesting network;
determine whether the requested network resource matches any network resource in the first network-resource pool or the second network-resource pool;
determine whether to perform a relocation procedure to relocate a network resource corresponding to the requested network resource from one network-resource pool to the other network-resource pool;
perform the relocation procedure, if the relocation procedure is determined to be performed; and
provide the requested network resource.

33. The apparatus according to claim 32, wherein the network resources comprise spectrum resources, the at least one network resource that corresponds to the first network-resource pool is initially assigned to the first network-resource pool.

34. The apparatus according to claim 32, wherein a first set of characteristics is associated with the first network-resource pool, a second set of characteristics is associated with the second network-resource pool, the first set of characteristics is applicable to the network resources of the first network-resource pool, the second set of characteristics is applicable to the network resources of the second network-resource pool, and the characteristics comprise at least one of user restrictions/authorizations, a priority in a scheme of priorities, technical parameters, and a set of policy rules.

35. The apparatus according to claim 32, wherein the apparatus comprises a network-resource management function.

36. The apparatus according to claim 32, further causing the apparatus to:
determine whether the requested resource is assigned to another network different than the requesting network, wherein the requested resource is blocked off if the requested resource is already assigned to another network.

37. The apparatus according to claim 32, further causing the apparatus to:
balance the amounts of network resources between the first network-resource pool and the second network-resource pool, wherein the balancing is performed in accordance to a predefined policy, and the balancing changes the applicable characteristics of at least one network resource by moving the at least one network resource from one network-resource pool to another network-resource pool.

38. The apparatus according to claim 32, wherein the relocation procedure is performed if the requested network resource is in a resource pool the requesting network does not have access to.

39. The apparatus according to claim 32, wherein the requested network resource is requested under Licensed Shared Access spectrum sharing concept.

40. An apparatus, comprising:
at least one processor and at least one memory including a computer program code, the at least one memory and the computer program code configured to, with the at least one processor, cause the apparatus at least to:
request, by a network entity, a network resource, wherein the requesting the network resource comprises requesting the network resource from a first network-resource pool and a second network-resource pool, at least one network resource corresponds to the first network-resource pool, and at least one network resource corresponds to the second network-resource pool;
receive a generated command based on the requested network resource;
initiate the generated command; and
report the result of initiating the generated command.

41. The apparatus of claim 40, wherein the network entity comprises a Resource Controller Function.

42. The apparatus of claim 40, wherein the receiving the generated command comprises receiving at least one of a grant/assign command and an evacuation command.

43. The apparatus according to claim 40, wherein the requested network resource is requested under Licensed Shared Access spectrum sharing concept.
